(19) United States
(12) Patent Application Publication
(10) Pub. No.: US 2007/0216522 A1
(43) Pub. Date: Sep. 20, 2007

(54) Illuminated window safety

(76) Inventors: Amy E. McCroskey, Kissimmee, FL (US); Raven Kotre, Kissimmee, FL (US)

Correspondence Address: CROSSLEY PATENT LAW, 400 SOUTH THIRD STREET, MONTROSE, CO, 81401, US

(21) Appl. No.: 11/384,164

(22) Filed: Mar. 20, 2006

(51) Int. Cl. B60Q 1/26

(52) U.S. Cl. 340/468

(57) ABSTRACT

An illuminated window safety screen for use in windows with frames and sills is described. A pair of vertical mounting tracks extends vertically from the sill, and has front and back edges and an inner area between. The inner area has at least two oppositely arranged pairs of engagement apertures for engaging the rigid support member. The rigid support member and interaction member are interlinked. They are sized to fit within the edges of the vertical mounting tracks and within the window frame and sill. The rigid support member has a top left engagement lock and a top right engagement lock. The engagement locks are movable between an engaged and disengaged position. The engagement locks are spring loaded locks. The panels have holes for airflow and the interaction member has cutouts for placement of shapes in the cutouts. There is a light located on the top of the rigid support member.

### BACKGROUND OF THE INVENTION

Many offerings exist by which the children can be protected from falling through a window. The devices offered, however, do not solve all problems associated with a window safety screen. If the child strikes the window, most safety devices do not protect the window from the impact, which can result in the window breaking and exposing the child to broken glass.

### FIELD OF THE INVENTION

The present invention relates to an ilumminated window safety screen for use in connection with protecting a child from falling through a window. The illuminated window safety screen has particular utility in connection with adding an additional layer of safety to the child through the prevention of injury from broken glass. Additionally, the illuminated window safety screen provides a nightlight for safety and a soothing effect. The illuminated window safety screen also functions as an interactive learning device. By moving shapes around on the screen children are helped with manipulative learning and can gain and improve eye hand coordination.

### DESCRIPTION OF THE PRIOR ART

Window safety screens are desirable for increasing safety in the home, especially important when children are present. Most products provide a barrier to falling through the window, such as U.S. Pat. No. 5,492,164 to Gist for a window safety system. The Gist '164 patent does not prevent the child from breaking the glass, and thus prevent the potential injury from the broken glass. Other products offer some protection to the glass but do not cover the entire lower window. For example, U.S. Pat. No. 5,454,415 to Bolling et al. discloses a child safety screen. However, the Bolling '415 patent does not provide the ventilation of the illuminated window safety screen, and has further drawbacks of an ungainly appearance.

While the above-described devices fulfill their respective and particular objects and requirements, they do not describe an illuminated window safety screen that provides for the advantages,of the present invention; therefore, a need exists for an improved illuminated window safety screen, particularly one that includes protection to the child both from falls and potential exposure to broken glass. Additionally, the illumination to the room from the illuminated window safety screen provides assurance to a child who is afraid of the dark, and allows a parent to check on a sleeping child without the need for additional light, which might wake the child. The illuminated window safety screen has an additional safety feature, which is the cushioning provided by the interaction member. The cushioning also makes the tactile sensation of placing the shapes in the cutouts more pleasing.

In this respect, the present invention substantially departs from the conventional concepts and designs of the prior art.

### SUMMARY OF THE INVENTION

In view of the foregoing disadvantages inherent in the known types of window safety devices now present in the prior art, the present invention provides an improved illuminated window safety screen, and overcomes the above-mentioned disadvantages and drawbacks of the prior art. As such, the general purpose of the present invention, which will be described subsequently in greater detail, is to provide a new and improved illuminated window safety screen and method which has all the advantages of the prior art mentioned heretofore and many novel features that result in an illuminated window safety screen which is not anticipated, rendered obvious, suggested or even implied by the prior art, either alone or in any combination thereof.

To attain this, the present invention essentially comprises an illuminated window safety screen for use in a standard type window having a frame and a sill. There is a pair of vertical mounting tracks with a front edge, a back edge and an inner portion between the edges. The vertical mounting tracks have holes formed through the inner portion of the vertical mounting tracks for the use of fasteners for securing the vertical mounting tracks to opposite inner portions of the window to hold the mounting tracks in the frame. The vertical mounting tracks extend vertically upward from the sill. The vertical mounting tracks have at least two pairs of engagement apertures that are oppositely arranged on the vertical mounting tracks to provide an easy and convenient way to lock the illuminated window safety screen in place. The engagement apertures extend through the inner portion of the vertical mounting tracks.

The screening portion of the illuminated window safety screen is composed of two inter-related screen, each with a different and useful purpose. The rigid support member is a planar panel having a top and a bottom side and a left and right side being sized to fit horizontally within said edges of said vertical mounting tracks and sized to fit vertically within the window frame and sill. There is an interaction member which is a planar panel having a top and a bottom side and a left and right side being sized to fit horizontally within said edges of said vertical mounting tracks and sized to fit vertically within the window frame and sill. The interaction member is connected to the rigid support member through any of the variety of conventional types of connections, these being illustratively, adhesion through the use of glues or similar, chemicals, formed grippers on one panel and engagement holes in the other panel, or any of the known connection types commonly in use.

An illumination source is located on the top of the rigid support member. The illumination source would be one of the commonly used nightlight type devices, which generally use low wattage light bulbs. The illumination source may be powered by electricity or solar powered or battery powered.

The illuminated window safety screen of claim further can have apertures aligned through the rigid support member and the interaction member. These apertures or holes, allow the free flow of air and light through the window. The apertures allow the window to be opened allowing fresh air in while maintaining the protective aspects. The interaction member can have a plurality of pre-determined cutouts, the cutouts being matched to a plurality of pre-determined shapes. The shapes have handles for easy removal and replacement in the cutout by a child. The interaction member will preferably be covered or formed from a softer material than the rigid, support member, to increase the tactile sensation the child has while playing with the shapes and to increase safety from accidental impact with the window.

The illuminated window safety screen means for securing the vertical mounting tracks to the window frame are formed holes in the inner area of the tracks and screws through the holes in the vertical mounting tracks into the inner portion of the window frame.

The rigid support member has a top left engagement lock and a top right engagement lock. With the engagement locks at opposite upper corners of the window safety screen, the window is thus protected. The engagement locks are changeable between an engaged position to keep the window safety screen in place, and a disengaged position to allow the window safety screen to be removed so the window may be cleaned or repaired. Said engagement locks are spring-loaded.

There has thus been outlined, rather broadly, the more important features of the invention in order that the detailed description thereof that follows may be better understood and in order that the present contribution to the art may be better appreciated.

The invention may also include interchangeable panels, so that as a child grows and learns to manipulate the one set of shapes, another set of shapes may be exchanged for the shapes in use. There are, of course, additional features of the invention that will be described hereinafter and which will form the subject matter of the claims attached.

It is therefore an object of the present invention to provide a new and improved illuminated window safety screen that has all of the advantages of the prior art window safety devices and none of the disadvantages.

It is another object of the present invention to provide a new and improved illuminated window safety screen that may be easily and efficiently manufactured and marketed.

An even further object of the present invention is to provide a new and improved illuminated window safety screen that has a low cost of manufacture with regard to both materials and labor, and which accordingly is then susceptible of low prices of sale to the consuming public, thereby making such illuminated window safety screen economically available to the buying public.

Still another object of the present invention is to provide a new illuminated window safety screen that provides in the apparatuses and methods of the prior art some of the advantages thereof, while simultaneously overcoming some of the disadvantages normally associated therewith.

Even still another object of the present invention is to provide an illuminated window safety screen that is of a durable and reliable construction.

Still yet another object of the present invention is to provide an illuminated window safety screen for preventing a child from falling through an open window.

A further object of the present invention is to prevent someone from coming inside the house through the window to grab or hurt a child or children.

Even another object of the present invention is to provide an illuminated window safety screen having an integral nightlight to provide additional light in the night. This is useful to both soothe a child who is afraid of the dark and to allow additional interaction time once the illuminated window safety screen is no longer lit by the sun.

Lastly, it is an object of the,present invention to provide a new and improved illuminated window safety screen for engaging a child in manipulative and cognitive learning by placement of the pre-determined shapes in the pre-determined cutouts of the interaction member. As the child's eye hand coordination increases, they become more adept and able to better coordinate their movements. The illuminated window,safety screen helps in the process by being a fun and useful tool for learning, while also increasing safety.

Thus has been broadly outlined the more important features of the illuminated window safety screen so that the detailed description thereof that follows may be better understood and in order that the present contribution to the art may be better appreciated.

Numerous objects, features and advantages of the illuminated window safety screen will be readily apparent to those of ordinary skill in the art upon reading the following detailed description of presently preferred, but nonetheless illustrative, embodiments of the illuminated window safety screen when taken in conjunction with the accompanying drawings. In this respect, before explaining the current embodiments of the illuminated window safety screen in detail, it is to be understood that the invention is not limited in its application to the details of construction and arrangements of the components set forth in the following description or illustration. The invention is capable of other embodiments and of being practiced and carried out in various ways. It is also to be understood that the phraseology and terminology employed herein are for purposes of description and should not be regarded as limiting.

Those skilled in the art will appreciate that the conception upon which this disclosure is based may readily be utilized as a basis for the design of other structures, methods and systems for carrying out the several purposes of the illuminated window safety screen. It is therefore important that the claims be regarded as including such equivalent constructions insofar as they do not depart from the spirit and scope of the present invention.

These together with additional objects of the illuminated window safety screen, along with various novel features that characterize the invention are particularly pointed out in the claims forming a part of this disclosure. For better understanding of the illuminated window safety screen, its operating advantages and specific objects attained by its uses refer to the accompanying drawings and description.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the illuminated window safety screen constructed in accordance with the principles of the present invention, showing an opened window and the illuminated window safety screen in an installed and operative position.

FIG. 2 is an exploded view of an illustrative shape, the interaction member, the rigid support member, and the illumination source of the illuminated window safety screen.

FIG. 3 is a perspective view of the locking mechanism of the illuminated window safety screen, showing the lock in both an engaged (or locked) and disengaged (or unlocked) position.

FIG. 4 is a perspective view of the vertical mounting track of the illuminated window safety screen.

FIG. 5 is a cross sectional view of the illuminated window safety screen, taken substantially along the lines 5-5 of FIG. 1.

The same reference numbers refer to the same parts throughout the various figures.

### DETAILED DESCRIPTION OF THE PREFERRED EMBODIMENT

Referring now to the drawings, a preferred embodiment of the illuminated window safety screen of the present invention is shown and generally designated by the reference numeral 10.

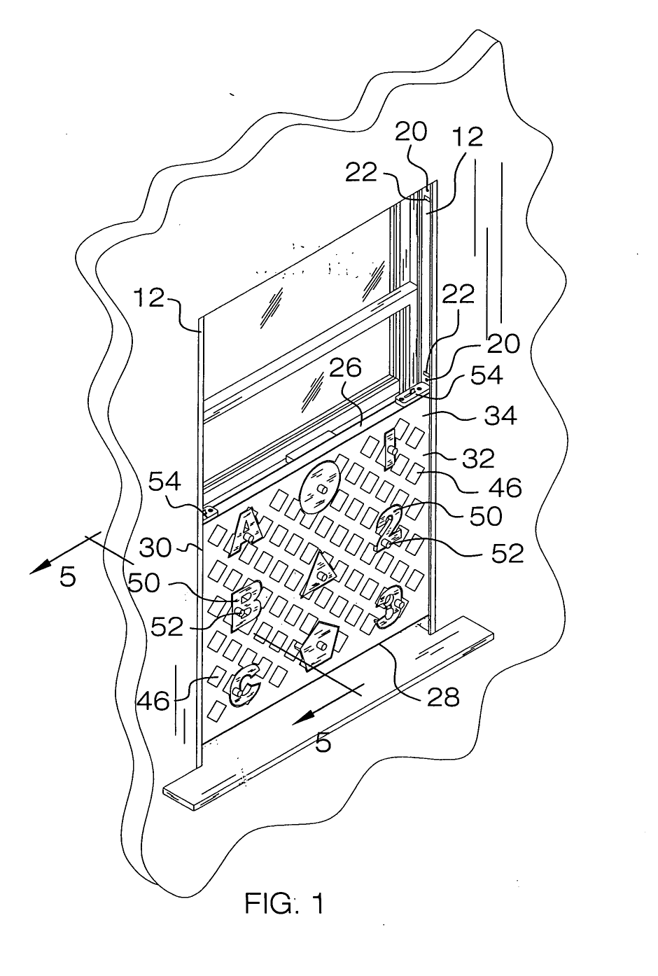

In FIG. 1, a new and improved illuminated window safety screen 10 of the present invention for enhanced window safety and children's interaction is illustrated and will be described. More particularly, the illuminated window safety screen 10 has a pair of vertical mounting tracks 12 which extending vertically from the sill having a front edge 14, a back edge 16 and an inner area 18 between the front edge 14 and the back edge 16. The inner area 18 of the vertical mounting tracks 12, have means for securing 20 to opposite inner portions of the window frame. The inner area 18 also has at least two oppositely arranged pairs of engagement apertures 22. A rigid support member 24 of generally planar shape is a panel having a top 26 and a bottom side 28, and a left side 30, and a right side 32. The rigid support member 24 is sized to fit horizontally within the edges of the vertical mounting tracks 12 and sized to fit vertically within the window frame and sill.

An interaction member 34 of generally planar shape is a panel having a top 36 and a bottom side 38, and a left side 40, and a right side 42. The interaction member 34 is sized to fit horizontally within the edges of the vertical mounting tracks 12 and sized to fit vertically within the window frame and sill. The interaction member 34 has connection means to the rigid support member 24.

There is an illumination means 44 is located on the top of the rigid support member 24.

The illuminated window safety screen 10 further has aligned apertures 46 transversing the rigid support member 24 and the interaction member 34. The interaction member 24 has a plurality of pre-determined cutouts 48 in the panel that match corresponding a plurality of pre-determined shapes 50 with handles 52. The rigid support member 24 has an engagement lock 54 on the top left and an engagement lock 54 on the top right.

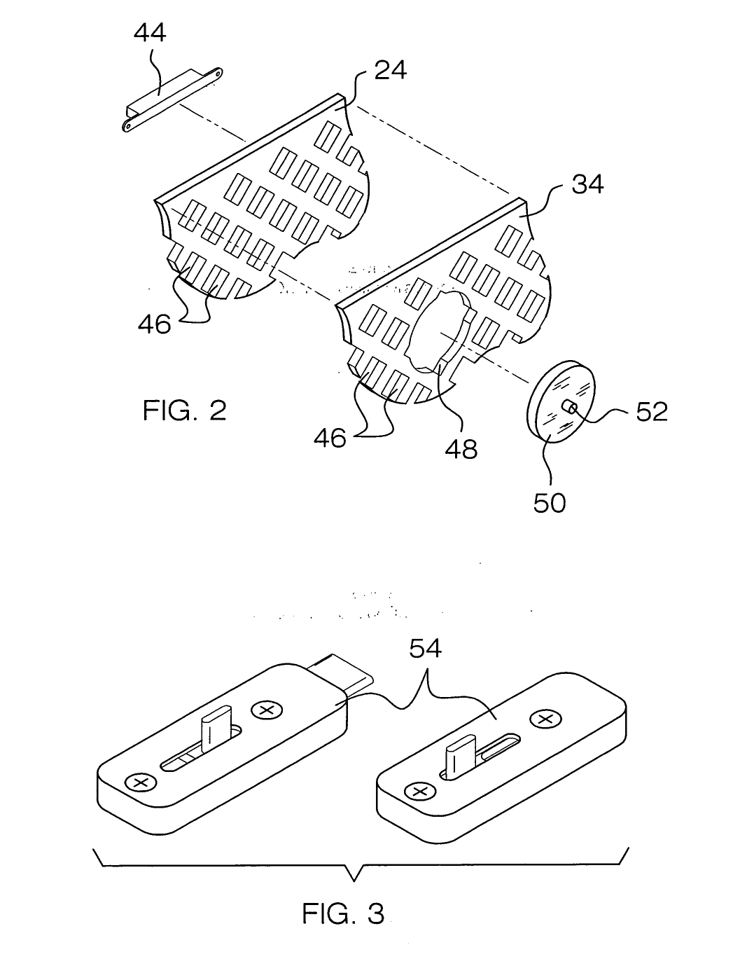

In FIG. 2 an exploded view of rigid support member 24 and the interaction member 34. The aligned apertures 46 transversing the rigid support member 24 and the interaction member 34 are shown. An illustrative pre-determined shape 50 with a handle 52 is shown as removed from the interaction member 34. An illumination source 44 is also shown. The illuminated window safety screen 10 may be powered by electricity or solar powered or battery powered.

FIG. 3 is a perspective view of the locking mechanism of the illuminated window safety screen 10, showing the engagement lock 54 in an engaged (or locked) position on the left and in a disengaged (or unlocked) position on the right. The engagement lock 54 further comprises a releasably engagable catch. Conventional screws could be used to secure the spring-loaded lock or the spring-loaded lock could be preformed or adhered using glue.

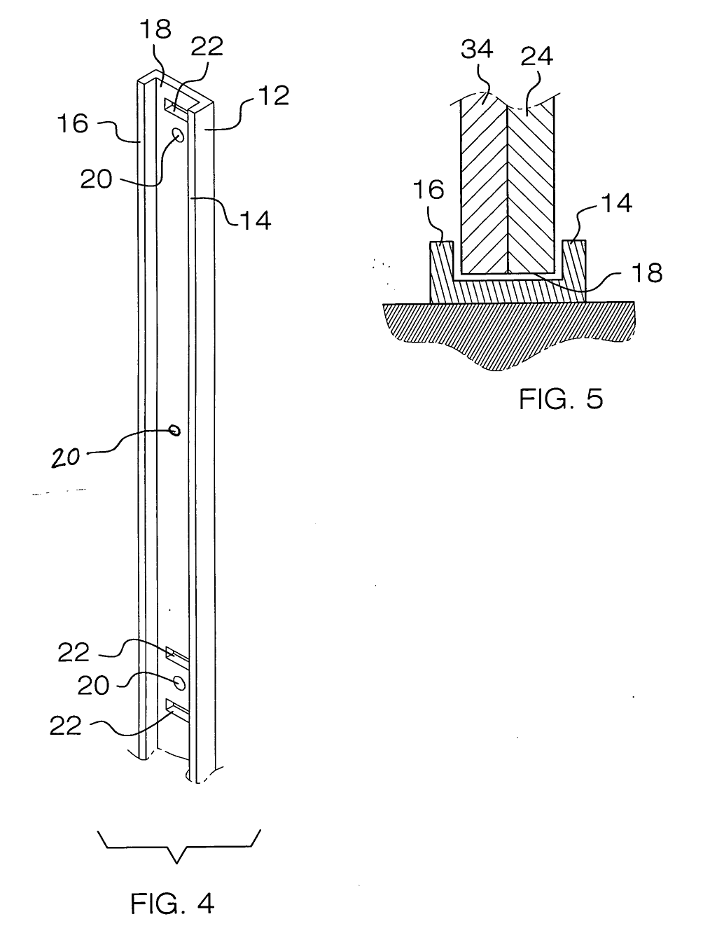

FIG. 4 is a perspective view of the vertical mounting track 12 which extending vertically from the sill showing the front edge 14, the back edge 16 and the inner area 18 between the front edge 14 and the back edge 16. The inner area 18 of the vertical mounting tracks 12, have means for securing 20 to opposite inner portions of the window frame. The inner area 18 also has at least two oppositely arranged pairs of engagement apertures 22. The vertical mounting track 12 must be at least one-half inch above the top left and right engagement locks 54.

FIG. 5 is a cross sectional view of the illuminated window safety screen 10, taken substantially along the lines 5-5 of FIG. 1. The mounting track 12 is shown as in use and mounted to the window frame. Shown is the vertical mounting track 12, the front edge 14, the back edge 16 and the inner area 18 between the front edge 14 and the back edge 16. The rigid support member 24 and interaction member 34 are shown fitting within the vertical mounting track 12.

For purposes of a detailed description the illuminated window safety screen has a pair of vertical mounting tracks which extending vertically from the sill having a front edge, a back edge and an inner area between the front edge and the back edge. The inner areas of the vertical mounting tracks have means for securing to opposite inner portions of the window frame. The means are holes provided through the inner area of the vertical mounting tracks through which screws will be driven into the inner portion of the window frame. The inner area also has at least two oppositely arranged pairs of engagement apertures. The pairs of engagement apertures are for retention of the rigid support member and interaction member through the engagement of the locks on the rigid support member. The rigid support member of generally planar shape is a panel having a top and a bottom side, and a left side, and a right side. The rigid support member is sized to fit horizontally within the edges of the vertical mounting tracks and sized to fit vertically within the window frame and sill.

An interaction member of generally planar shape is a panel having a top and a bottom side, and a left side, and a right side. The interaction member is sized to fit horizontally within the edges of the vertical mounting tracks and sized to fit vertically within the window frame and sill. The interaction member has connection means to the rigid support member.

There is an illumination means is located on the top of the rigid support member.

The illuminated window safety screen further has aligned apertures transversing the rigid support member and the interaction member. The interaction member has a plurality of pre-determined cutouts in the panel that match corresponding a plurality of pre-determined shapes with handles. The rigid support member has an engagement lock on the top left and an engagement lock on the top right.

The inventors developed the idea for this invention after observing their children's interactions with windows. The fear of a child falling was substantial but the possibility of a child striking the window and breaking the glass was also present. Also, parents' fearing for the safety of their child or children from intruders entering from the outside through the child's or children's bedroom needed to be addressed. The window safety screen was developed to overcome these problems. The cutouts and shapes were introduced to provide an additional opportunity for children to develop their manipulative skills and improve hand eye coordination. Additionally, illuminiation was added to soothe a child who is afraid of the dark and allow a parent to check a sleeping child without introducing more light into the room and perhaps waking the child.

In use, it can now be understood that the illuminated window safety screen provides an improved window safety screen. The window is shielded to prevent a child from falling out and also to prevent the child from breaking the window glass by striking it. The rigid support member provides the resilience and shielding of the window and would be formed from a suitable plastic or polymer. The interaction member would be formed from a less resilient layer of material, and could be wrapped in a type of foam for increased safety. The nightlight is a typical low wattage type nightlight; and will provide light to soothe a child who is afraid of the dark and also provide light to check the child while sleeping. The removable shapes will help increase manipulative and cognitive learning and improve eye hand coordination.

While a preferred embodiment of the illuminated window safety screen has been described in detail, it should be apparent that modifications and variations thereto are possible, all of which fall within the true spirit and scope of the invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be compassed by the present invention. And although home uses have been described, it should be appreciated that the illuminated window safety screen herein described is also suitable for use in a larger range of environments. Furthermore, a wide variety of shapes and colors may be used instead of the representative shapes depicted in the figures.

Therefore, the foregoing is considered as illustrative only of the principles of the invention. Further, since numerous modifications and changes will readily occur to those skilled in the art, it is not desired to limit the invention to the exact construction and operation shown and described and accordingly, all suitable modifications and equivalents may be resorted to, falling within the scope of the invention.

What is claimed is:

1. An illuminated window safety screen for use in a window having a frame and a sill comprising:
a pair of vertical mounting tracks extending vertically from the sill having a front edge, a back edge and an inner area therebetween having means for securing to opposite inner portions of the window frame, said inner area having at least two oppositely arranged pairs of engagement apertures;
a rigid support member being a planar panel having a top and a bottom side and a left and a right side being sized to fit horizontally within said edges of said vertical mounting tracks and sized to fit vertically within the window frame and sill;
an interaction member being a planar panel having a top and a bottom side and a left and a right side being sized to fit horizontally within said edges of said vertical mounting tracks and sized to fit vertically within the window frame and sill, said interaction member having connection means to said rigid support member;
an illumination means located on said top of said rigid support member.

2. The illuminated window safety screen of claim 1 further comprising:
aligned apertures transversing said rigid support member and said interaction member.

3. The illuminated window safety screen of claim 2 further comprising:
a plurality of pre-determined cutouts in said interaction member.

4. The illuminated window safety screen of claim 3 further comprising:
a plurality of pre-determined shapes.

5. The illuminated window safety screen of claim 4 wherein said a plurality of pre-determined shapes have handles.

6. The illuminated window safety screen of claim 1 wherein said means for securing said vertical mounting tracks are formed apertures and screws through said vertical mounting tracks into the inner portion of the window frame.

7. The illuminated window safety screen of claim 1 wherein said rigid support member has an engagement lock on said top left and an engagement lock on said top right.

8. The illuminated window safety screen, of claim 7 wherein said engagement locks are movable between an engaged and disengaged position and are spring-loaded.

9. An illuminated window safety screen for use in a window having a frame and a sill comprising:
a pair of vertical mounting tracks extending vertically from the sill having a front edge, a back edge and an inner area therebetween having means for securing to opposite inner portions of the window frame wherein said means for securing said vertical mounting tracks are formed apertures and screws through said vertical mounting tracks into the inner portion of the window frame, said inner area having at least two oppositely arranged pairs of engagement apertures;
a rigid support member being a planar panel having a top and a bottom side and a left and a right side being sized to fit horizontally within said edges of said vertical mounting tracks and sized to fit vertically within the window frame and sill, said rigid support member has an engagement lock on said top left left and an engagement lock on said top right;
an interaction member being a planar panel having a top and a bottom side and a left and a right side being sized to fit horizontally within said edges of said vertical mounting tracks and sized to fit vertically within the window frame and sill, said interaction member having connection means to said rigid support member;
an illumination means located on said top of said rigid support member.

10. The illuminated window safety screen of claim 9 further comprising: aligned apertures transversing said rigid support member and said interaction member.

11. The illuminated window safety screen of claim 10 further comprising:
a plurality of pre-determined cutouts in said interaction member.

12. The illuminated window safety screen of claim 11 further comprising:
a plurality of pre-determined shapes with handles.

13. The illuminated window safety screen of claim 9 wherein said engagement locks are movable between an engaged and disengaged position.

14. An illuminated window safety screen for use in a window having a frame and a sill comprising:
a pair of vertical mounting tracks extending vertically from the sill having a front edge, a back edge and an inner area therebetween having means for securing to opposite inner portions of the window frame wherein said, means for securing said vertical mounting tracks are formed apertures and screws through said vertical mounting tracks into the inner portion of the window frame, said inner area having at least two oppositely arranged pairs of engagement apertures;
a rigid support member being a planar panel having a top and a bottom side and a left and a right side being sized to fit horizontally within said edges of said vertical mounting tracks and sized to fit vertically within the window frame and sill, said rigid support member has an engagement lock on said top left and an engagement lock on said top right, wherein said engagement locks are movable between an engaged and disengaged position and are spring-loaded;
an interaction member being a planar panel having a top and a bottom side and a left and a right side being sized to fit horizontally within said edges of said vertical mounting tracks and sized to fit vertically within the window frame and sill, said interaction member having connection means to said rigid support member;
an illumination means located on said top of said rigid support member.

15. The illuminated window safety screen of claim 14 further comprising:
aligned apertures transversing said rigid support member and said interaction member.

16. The illuminated window-safety screen of claim 15 further comprising:
a plurality of pre-determined cutouts in said interaction member.

17. The illuminated window safety screen of claim 16 further comprising:
a plurality of pre-determined shapes with handles.
